(19) United States
(12) Patent Application Publication
(10) Pub. No.: US 2024/0178872 A1
(43) Pub. Date: May 30, 2024

(54) CASE DEVICE AND RELATED ELECTRONIC APPARATUS

(71) Applicant: Chi-Hsiang Chang, Taipei City (TW)

(72) Inventor: Chi-Hsiang Chang, Taipei City (TW)

(21) Appl. No.: 17/994,012

(22) Filed: Nov. 25, 2022

(51) Int. Cl. H04B 1/3888

(52) U.S. Cl. CPC H04B 1/3888

(57) ABSTRACT

A case device configured to be installed on an electronic device is provided. The case device includes a case component, a supporting frame, a connecting column and a hinge component. The case component includes a body portion and a connecting portion. The body portion surrounds the electronic device and includes a bottom wall. The connecting portion is connected to the bottom wall of the body portion. An accommodating chamber is formed inside the connecting portion. The connecting column is connected to the supporting frame. The hinge component is connected to the connecting column and the connecting portion. The connecting column and the hinge component are at least partially accommodated inside the accommodating chamber. The supporting frame can be pivotally folded or unfolded relative to the case component by the hinge component. Besides, a related electronic apparatus is provided.

### BACKGROUND OF THE INVENTION

### 1. Field of the Invention

The invention relates to a case device and a related apparatus; more specifically, a case device with multi-functions and for reducing pressure of users' hands, and a related electronic apparatus.

### 2. Description of the Prior Art

More users use portable electronic devices such as smartphones, to take photos or watch videos. However, those devices are not easy to hold. Therefore, holding those devices for a long time causes uncomfortable result to users' hands.

### SUMMARY OF THE INVENTION

The invention provides a case device with multi-functions and for reducing pressure of users' hands, and a related electronic apparatus for solving the above problems.

To achieve the above objective, the invention discloses a case device configured to be installed on an electronic device. The case device includes a case component, a supporting frame, a connecting column and a hinge component. The case component includes a body portion and a connecting portion. The body portion surrounds the electronic device, and the body portion includes a bottom wall. The connecting portion is connected to the bottom wall of the body portion. An accommodating chamber is formed inside the connecting portion. The connecting portion is integrally or detachably connected to the bottom wall of the body portion. The connecting column is connected to the supporting frame. The connecting column is integrally or detachably connected to the supporting frame. The hinge component is connected to the connecting column and the connecting portion. The connecting column and the hinge component are at least partially accommodated inside the accommodating chamber. The supporting frame is pivotally folded or unfolded relative to the case component by the hinge component. The hinge component is detachably connected to one of the connecting column and the connecting portion and integrally connected to another one of the connecting column and the connecting portion, or the hinge component is detachably connected to both of the connecting column and the connecting portion.

According to an embodiment of the invention, the body portion further includes a top wall, a left wall and a right wall. The top wall and the bottom wall are opposite to each other and extend along a width direction of the case device. The left wall and the right wall are opposite to each other and connected to the top wall and the bottom wall. The left wall and the right wall extend along a length direction of the case device. The connecting portion protrudes from the bottom wall of the body portion along the length direction of the case device, and the connecting column and the hinge component are at least partially accommodated inside the accommodating chamber along the width direction of the case device.

According to an embodiment of the invention, the supporting frame includes a left frame body, a right frame body and a connecting frame body. The left frame body and the right frame body are respectively adjacent to a left wall and a right wall of the body portion. The connecting frame body is connected to the left frame body and the right frame body. The connecting column is connected to the left frame body or the right frame body. The left frame body and the right frame body respectively overlap the left wall and the right wall of the body portion when the supporting frame is pivotally folded relative to the case component.

According to an embodiment of the invention, the supporting frame is formed in U shape, L shape or J shape.

To achieve the above objective, the invention further discloses an electronic apparatus. The electronic apparatus includes a main body and a case device. The case device is combined with the main body, and the case device includes a case component, a supporting frame, a connecting column and a hinge component. The case component includes a body portion and a connecting portion. The body portion surrounds the main body, and the body portion includes a bottom wall. The connecting portion is connected to the bottom wall of the body portion. An accommodating chamber is formed inside the connecting portion. The connecting portion is integrally or detachably connected to the bottom wall of the body portion. The connecting column is connected to the supporting frame. The connecting column is integrally or detachably connected to the supporting frame. The hinge component is connected to the connecting column and the connecting portion. The connecting column and the hinge component are at least partially accommodated inside the accommodating chamber. The supporting frame is pivotally folded or unfolded relative to the case component by the hinge component. The hinge component is detachably connected to one of the connecting column and the connecting portion and integrally connected to another one of the connecting column and the connecting portion, or the hinge component is detachably connected to both of the connecting column and the connecting portion.

According to an embodiment of the invention, the body portion further includes a top wall, a left wall and a right wall. The top wall and the bottom wall are opposite to each other and extend along a width direction of the case device. The left wall and the right wall are opposite to each other and connected to the top wall and the bottom wall. The left wall and the right wall extend along a length direction of the case device. The connecting portion protrudes from the bottom wall of the body portion along the length direction of the case device, and the connecting column and the hinge component are at least partially accommodated inside the accommodating chamber along the width direction of the case device.

According to an embodiment of the invention, the supporting frame includes a left frame body, a right frame body and a connecting frame body. The left frame body and the right frame body are respectively adjacent to a left wall and a right wall of the body portion. The connecting frame body is connected to the left frame body and the right frame body. The connecting column is connected to the left frame body or the right frame body. The left frame body and the right frame body respectively overlap the left wall and the right wall of the body portion when the supporting frame is pivotally folded relative to the case component.

According to an embodiment of the invention, the supporting frame is formed in U shape, L shape or J shape.

In summary, in the invention, the supporting frame pivotally movable relative to the case component can be held by a user or used to place or hang the electronic device or the electronic apparatus. The user can adjust an angle of the electronic device or the electronic apparatus to watch contents or take photos conveniently by pivotally moving the supporting frame. Therefore, the invention can provide better user experience and reduce pressure of the user's hands. Besides, in the invention, a size of the case device does not change significantly in width or thickness directions. Therefore, the invention can provide better aesthetic appearance and comfortable grip.

These and other objectives of the invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a case device installed on an electronic device according to a first embodiment of the invention.

FIG. 2 is a diagram of the case device detached from the electronic device according to the first embodiment of the invention.

FIG. 3 is an exploded diagram of the case device according to the first embodiment of the invention.

FIG. 4 is another exploded diagram of the case device according to the first embodiment of the invention.

FIG. 5 is a partial diagram of the case device according to the first embodiment of the invention.

FIG. 6 to FIG. 8 are diagrams of the case device in different states according to the first embodiment of the invention.

FIG. 9 is a partial diagram of a case device according to a second embodiment of the invention.

FIG. 10 is a partial exploded diagram of the case device according to the second embodiment of the invention.

FIG. 11 is a partial exploded diagram of an electronic apparatus according to a third embodiment of the invention.

### DETAILED DESCRIPTION

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “left”, “right”, “front”, “back”, etc., is used with reference to the orientation of the Figure (s) being described. The components of the invention can be positioned in a number of different orientations.

As such, the directional terminology is used for purposes of illustration and is in no way limiting. Accordingly, the drawings and descriptions will be regarded as illustrative in nature and not as restrictive. Also, if not specified, the term “connect” is intended to mean either an indirect or direct mechanical connection. Thus, if a first device is connected to a second device, that connection may be through a direct mechanical connection, or through an indirect mechanical connection via other devices and connections.

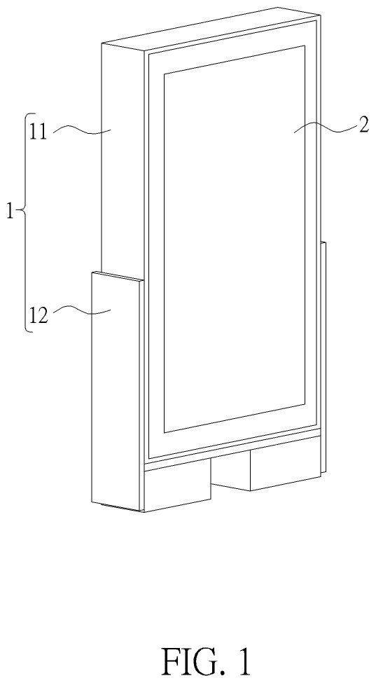

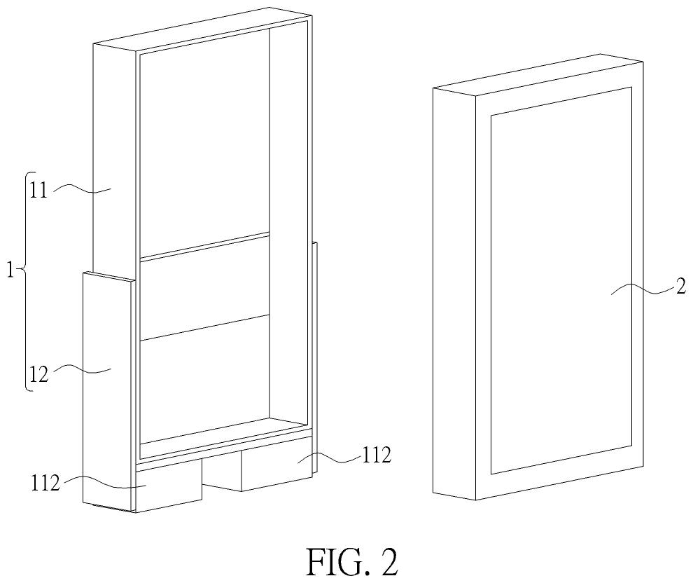

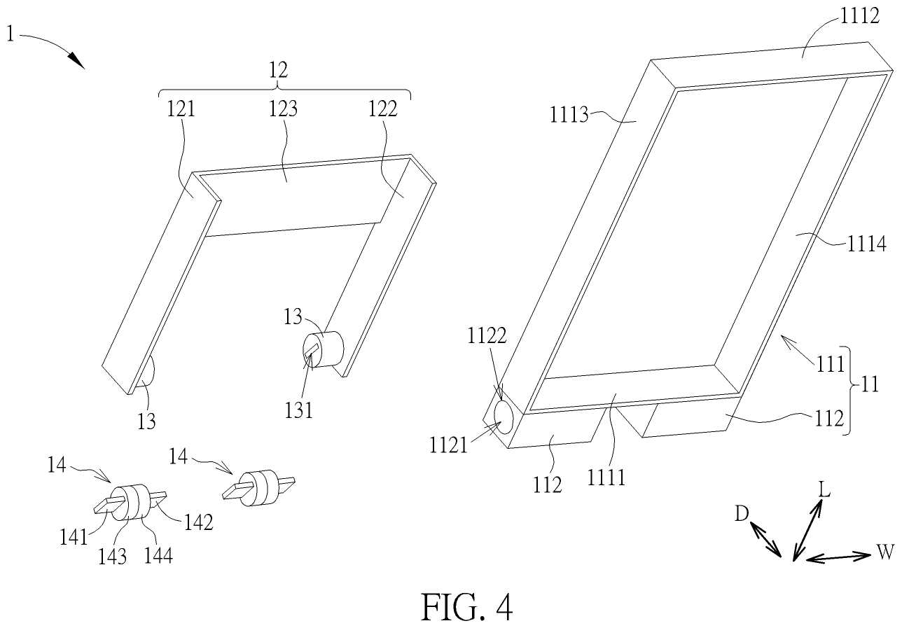

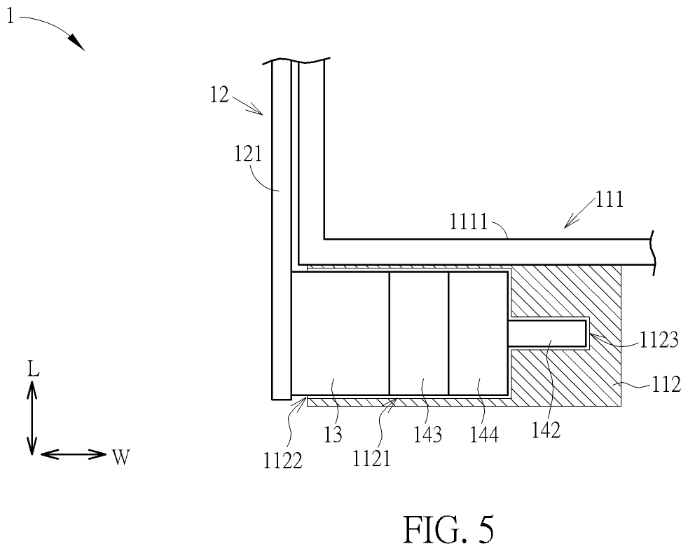

As shown in FIG. 1 to FIG. 5, in a first embodiment, a case device 1 is detachably installed on an electronic device 2. The electronic device 2 can be a portable device, such as a mobile phone or a tablet computer. The case device 1 includes a case component 11, a supporting frame 12, two connecting columns 13 and two hinge components 14. The case component 11 includes a body portion 111 and two connecting portions 112. The body portion 111 surrounds the electronic device 2. For example, an outer periphery of the electronic device 2 can be surrounded and covered by the body portion 111. The two connecting portions 112 are connected to the body portion 111. An accommodating chamber 1121 is formed inside each of the connecting portions 112. Each of the connecting columns 13 is connected to the supporting frame 12. Each of the hinge components 14 is connected to the corresponding connecting column 13 and the corresponding connecting portion 112. Each of the connecting columns 13 and the corresponding hinge component 14 are at least partially accommodated inside the corresponding accommodating chamber 1121. The supporting frame 12 can be pivotally folded or unfolded relative to the case component 11 by the two hinge components 14.

However, the numbers of the connecting column, the hinge component and the connecting portion are not limited to this embodiment. For example, in another embodiment, the case device can include only one connecting column and one hinge component located at one side or located centrally, and accordingly, the case component can include only one connecting portion located at one side or located centrally.

Specifically, in this embodiment, as shown in FIG. 1 to FIG. 5, the body portion 111 includes a bottom wall 1111, a top wall 1112, a left wall 1113 and a right wall 1114. The top wall 1112 and the bottom wall 1111 are opposite to each other and extend along a width direction W of the case device 1. The left wall 1113 and the right wall 1114 are opposite to each other and connected to the top wall 1112 and the bottom wall 1111. The left wall 1113 and the right wall 1114 extend along a length direction L of the case device 1. Each of the connecting portions 112 is connected to the bottom wall 1111 of the body portion 111 and protrudes from the bottom wall 1111 of the body portion 111 along the length direction L of the case device 1. The connecting portion 112 located at a left side does not protrude from the left wall 1113 of the body portion 111 along the width direction W of the case device 1. The connecting portion 112 located at a right side does not protrude from the right wall 1114 of the body portion 111 along the width direction W of the case device 1. A size of each of the connecting portions 112 along a thickness direction D of the case device 1 can be equal to a size of the bottom wall 1111 along the thickness direction D of the case device 1, so that a size of the case device 1 along the width direction W and a size of the case device 1 along the thickness direction D do not change significantly. Therefore, the invention can provide better aesthetic appearance and comfortable grip.

However, the invention is not limited to this embodiment. For example, in another embodiment, the size of each of the connecting portion along the thickness direction can be less than the size of the bottom wall along the thickness direction.

Furthermore, in this embodiment, each of the connecting portions 112 can be integrally connected to the bottom wall 1111 of the body portion 111, e.g., by welding or injection molding manners. However, the invention is not limited to this embodiment. For example, in another embodiment, the connecting portion can be detachably connected to the bottom wall of the body portion, e.g., by screwing or magnetic attraction manners.

Besides, in this embodiment, the supporting frame 12 is formed in U shape and includes a left frame body 121, a right frame body 122 and a connecting frame body 123. The left frame body 121 and the right frame body 122 are opposite to each other and respectively adjacent to the left wall 1113 and the right wall 1114 of the body portion 111. The connecting frame body 123 is connected to the left frame body 121 and the right frame body 122. The two connecting columns 13 are respectively connected to the left frame body 121 and the right frame body 122. The left frame body 121 and the right frame body 122 respectively overlap the left wall 1113 and the right wall 1114 of the body portion 111 when the supporting frame 12 is pivotally folded relative to the case component 11.

However, the invention is not limited to this embodiment. For example, in another embodiment, the supporting frame can be formed in L shape and include the left frame body and the connecting frame body only, or include the right frame body and the connecting frame body only. Alternatively, in another embodiment, the supporting frame can be formed in J shape and include the left frame body, the right frame body and the connecting frame body, wherein the left frame body and the right frame body have different lengths, and there is only one connecting portion, one hinge component and one connecting column connected to a longer one of the left frame body and the right frame body and pivotally connected to the connecting portion by the corresponding hinge component.

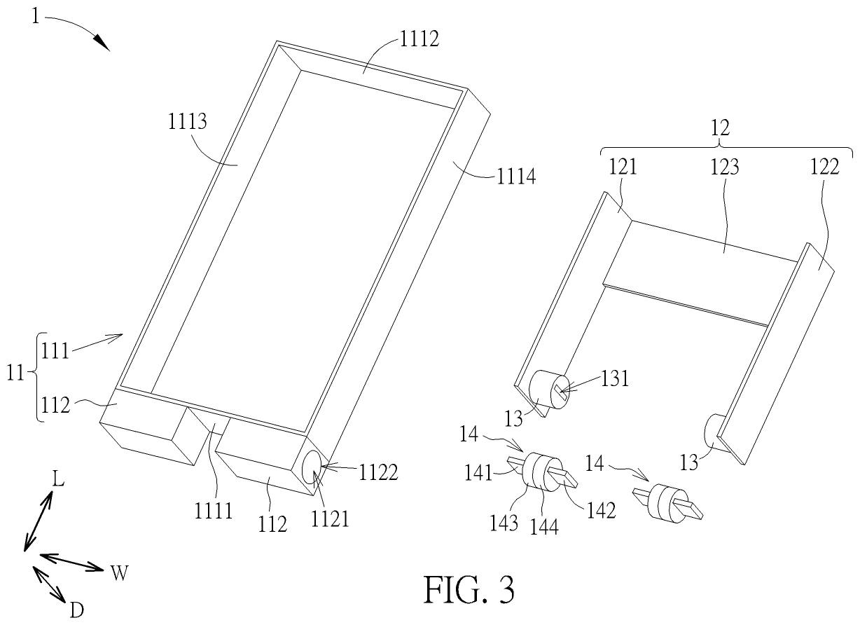

As shown in FIG. 3 to FIG. 5, in order for easy assembly, each of the connecting portions 112 further includes an opening structure 1122. Each of the opening structures 1122 is communicated with the corresponding accommodating chamber 1121. Each of the connecting columns 13 and the corresponding hinge component 14 are at least accommodated inside the corresponding accommodating chamber 1121 through the corresponding opening structure 1122 along the width direction W of the case device 1.

In addition, in this embodiment, each of the connecting columns 13 can be integrally connected to the supporting frame 12, e.g., by welding or injection molding manners. However, the invention is not limited to this embodiment. For example, in another embodiment, the connecting column can be detachably connected to the supporting frame, e.g., by screwing or magnetic attraction manners.

As shown in FIG. 3 to FIG. 5, a first positioning protrusion 141 and a second positioning protrusion 142 are respectively formed on two ends of each of the hinge components 14. Specifically, each of the hinge components 14 includes a first hinge portion 143 and a second hinge portion 144 coaxially and pivotally connected to the first hinge portion 143. The first positioning protrusion 141 is formed on the first hinge portion 143. The second positioning protrusion 142 is formed on the second hinge portion 144. A first positioning recess structure 131 is formed on each of connecting columns 13. A second positioning recess structure 1123 is formed on a wall of each of the accommodating chamber 1121. The first positioning 1 recess structure 131 and the second positioning structure 1123 have shapes respectively matching with shapes of the first positioning protrusion 141 and the second positioning protrusion 142. Each of the first positioning protrusions 141 is inserted into the corresponding first positioning recess structure 131 for achieving a connection of the each of the hinge components 14 and the corresponding connecting column 13. Each of the second positioning protrusions 142 is inserted into the corresponding second positioning recess structure 1123 for achieving a connection of each of the hinge components 14 and the corresponding connecting portion 112. The supporting frame 12 can be pivotally moved relative to the case component 11 by rotation of the first hinge portions 143 relative to the second hinge portions 144.

In this embodiment, the first positioning protrusion 141 and the second positioning protrusion 142 can be two identical cuboids. However, the invention is not limited to this embodiment. For example, in another embodiment, the first positioning protrusion and the second positioning protrusion can be two different cuboids, two identical hexagonal columns, or two different hexagonal columns. Alternatively, in another embodiment, the first positioning protrusion and the second positioning protrusion can be a cuboid and a hexagonal column respectively.

Moreover, in this embodiment, a user can remove the first positioning protrusion 141 and the second positioning protrusion 142 of each of the hinge components 14 from the corresponding first positioning recess structure 131 and the corresponding second positioning recess structure 1123 for separating each of the hinge components 14 from the corresponding connecting column 13 and the corresponding connecting portion 112. That is, each of the hinge components 14 is detachably connected to the corresponding connecting column 13 and the corresponding connecting portion 112. However, the invention is not limited to this embodiment. For example, in another embodiment the hinge component can be detachably connected to one of the connecting column and the connecting portion, e.g., by screwing or magnetic attraction manners, and integrally connected to the other one of the connecting column and the connecting portion, e.g., by welding or injection molding manners.

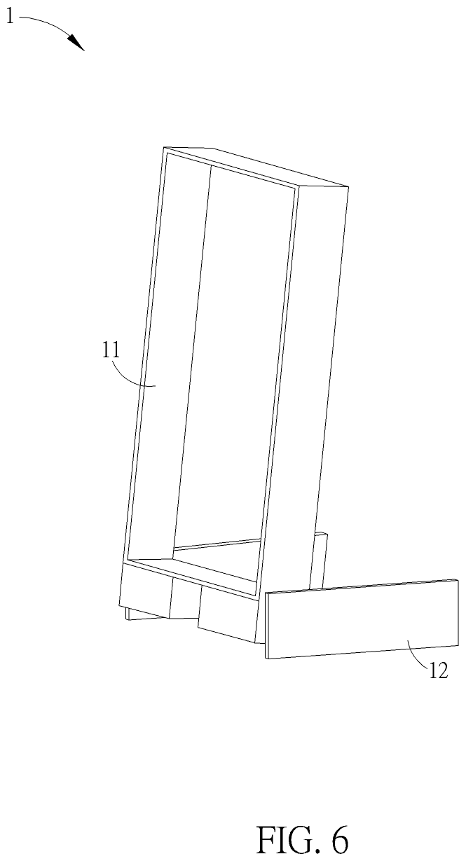

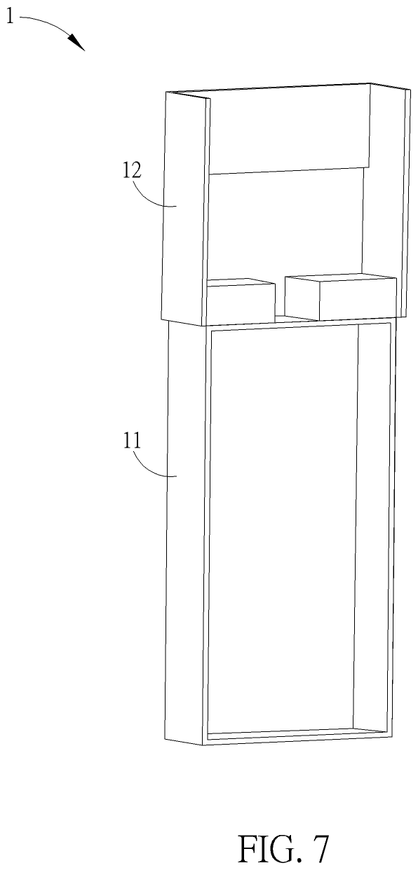

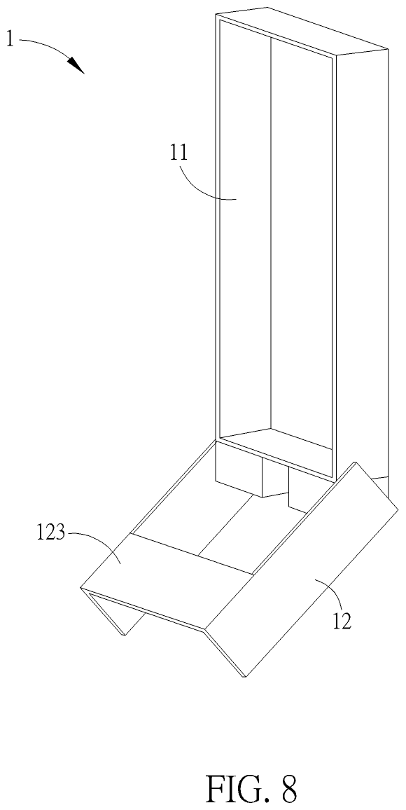

The above configuration allows the user to operate the supporting frame 12 to pivotally move relative to the case component 11 to different positions according to practical demands. The supporting frame 12 pivotally movable relative to the case component 11 can be held by a user or used to place or hang the electronic device 2. For example, the user can operate the supporting frame 12 to pivotally move to an overlapped position as shown in FIG. 1, where the supporting frame 12 overlaps the case component 11, so that the electronic device 2 can be horizontally placed on a desktop, not shown in the figures, or be easily held by the user's hands. Alternatively, the user can operate the supporting frame 12 to pivotally move to a first inclined position as shown in FIG. 6, so that the electronic device 2 can obliquely stand on the desktop. Alternatively, the user can operate the supporting frame 12 to pivotally move to a hung position as shown in FIG. 7, where the supporting frame 12 is parallel to the case component 11, so that the electronic device 2 can be hung on a hook, not shown in the figures, by the supporting frame 12. Alternatively, the user can operate the supporting frame 12 to pivotally move to a second inclined position as shown in FIG. 8, so that it is convenient for the user to use the electronic device 2 to take selfies by holding the connecting frame body 123 of the supporting frame 12. The invention allows the user to adjust an angle of the electronic device or the electronic apparatus to watch contents or take photos conveniently by pivotally moving the supporting frame. Therefore, the invention can provide better user experience and reduce pressure of the user's hands. Besides, in the invention, the size of the case device along the width direction and the size of the case device along the thickness direction do not change significantly. Therefore, the invention can provide better aesthetic appearance and comfortable grip.

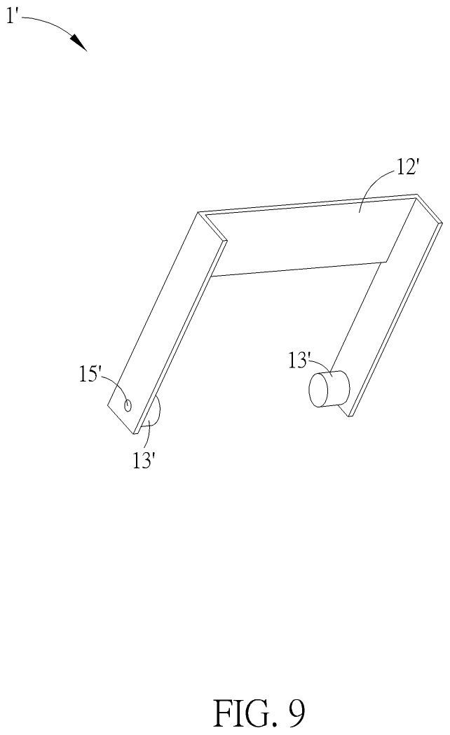

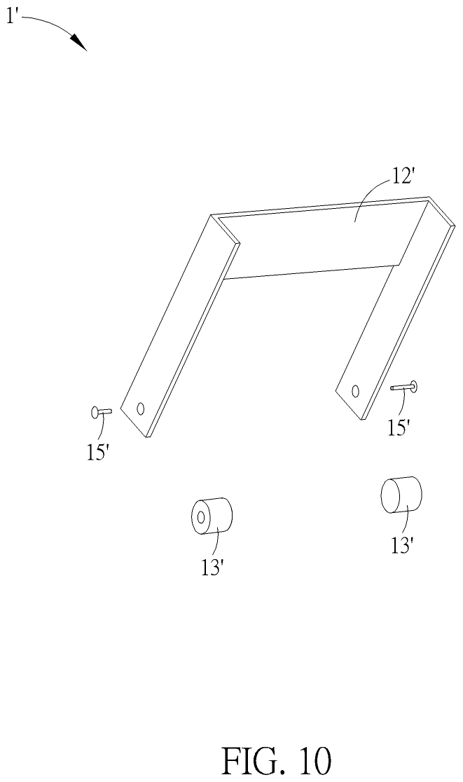

As shown in FIG. 9 and FIG. 10, different from the first embodiment, in a second embodiment, each of connecting columns 13′ of a case device 1′ is detachably connected to a supporting frame 12′. Specifically, the case device 1′ further includes two fastening components 15′. The fastening component 15′ can be a screw member or a rivet member. Each of the connecting columns 13′ is detachably connected to the supporting frame 12′ by the corresponding fastening component 15′. Understandably, in another embodiment, the case device can include only one fastening component when the case device includes only one connecting column.

Other details of the case device 1′ of the second embodiment are similar to the ones of the first embodiment. Detailed description is omitted herein for simplicity.

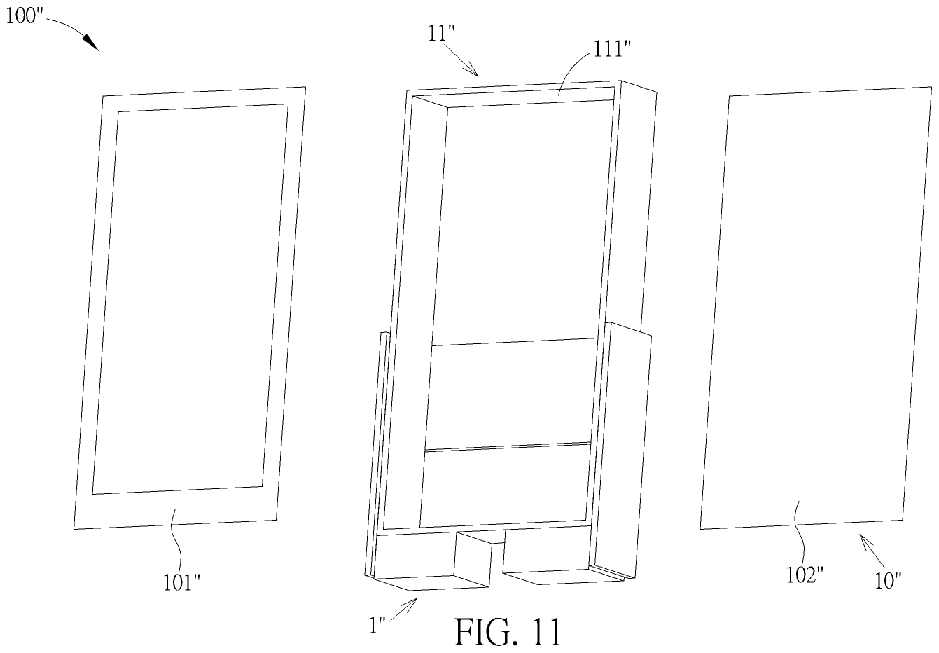

As shown in FIG. 11, different from the above embodiments, in a third embodiment, an electronic apparatus 100″ can be a portable apparatus, such as a mobile phone or tablet computer, and includes a case device 1″ and a main body 10″. The case device 1″ is combined with the main body 10″. A body portion 111″ of a case component 11″ surrounds the main body 10″. That is, the case device 1″ is a part of the electronic apparatus 100″. Specifically, the main body 10″ includes a first structure 101″ and a second structure 102″ The case device 1″ is disposed between the first structure 101″ and the second structure 102″ and for connecting the first structure 101″ to the second structure 102″. The first structure 101″ can be a monitor of the electronic apparatus. The second structure 102″ can be a rear cover of the electronic apparatus. An accommodating space is enclosed by the main body 10″ and the case device 1″ cooperatively for accommodating other electronic components, such as a circuit board, a camera, a battery, or a speaker. However, the invention is not limited to the invention. For example, in another embodiment, the main body can further include a third structure, e.g., a border, disposed on the first structure and the second structure and for connecting the first structure and the second structure, and the case device is fixedly combined with the third embodiment.

Other details of the case device 1″ of the third embodiment are similar to the ones of any one of the above embodiments. Detailed description is omitted herein for simplicity.

In contrast to the prior art, in the invention, the supporting frame pivotally movable relative to the case component can be held by a user or used to place or hang the electronic device or the electronic apparatus. The user can adjust an angle of the electronic device or the electronic apparatus to watch contents or take photos conveniently by pivotally moving the supporting frame. Therefore, the invention can provide better user experience and reduce pressure of the user's hands. Besides, in the invention, a size of the case device does not change significantly in width or thickness directions. Therefore, the invention can provide better aesthetic appearance and comfortable grip.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A case device configured to be installed on an electronic device, the case device comprising:
a case component comprising:
a body portion surrounding the electronic device, and the body portion comprising a bottom wall; and
a connecting portion connected to the bottom wall of the body portion, an accommodating chamber being formed inside the connecting portion, the connecting portion being integrally or detachably connected to the bottom wall of the body portion;
a supporting frame;
a connecting column connected to the supporting frame, the connecting column being integrally or detachably connected to the supporting frame; and
a hinge component connected to the connecting column and the connecting portion, the connecting column and the hinge component being at least partially accommodated inside the accommodating chamber, the supporting frame being pivotally folded or unfolded relative to the case component by the hinge component, the hinge component being detachably connected to one of the connecting column and the connecting portion and integrally connected to another one of the connecting column and the connecting portion, or the hinge component being detachably connected to both of the connecting column and the connecting portion.

2. The case device of claim 1, wherein the body portion further comprises a top wall, a left wall and a right wall, the top wall and the bottom wall are opposite to each other and extend along a width direction of the case device, the left wall and the right wall are opposite to each other and connected to the top wall and the bottom wall, the left wall and the right wall extend along a length direction of the case device, the connecting portion protrudes from the bottom wall of the body portion along the length direction of the case device, and the connecting column and the hinge component are at least partially accommodated inside the accommodating chamber along the width direction of the case device.

3. The case device of claim 1, wherein the supporting frame comprises a left frame body, a right frame body and a connecting frame body, the left frame body and the right frame body are respectively adjacent to a left wall and a right wall of the body portion, the connecting frame body is connected to the left frame body and the right frame body, the connecting column is connected to the left frame body or the right frame body, the left frame body and the right frame body respectively overlap the left wall and the right wall of the body portion when the supporting frame is pivotally folded relative to the case component.

4. The case device of claim 1, wherein the supporting frame is formed in U shape, L shape or J shape.

5. An electronic apparatus comprising:
a main body; and
a case device combined with the main body, and the case device comprising:
a case component comprising:
a body portion surrounding the main body, and the body portion comprising a bottom wall; and
a connecting portion connected to the bottom wall of the body portion, an accommodating chamber being formed inside the connecting portion, the connecting portion being integrally or detachably connected to the bottom wall of the body portion;
a supporting frame;
a connecting column connected to the supporting frame, the connecting column being integrally or detachably connected to the supporting frame; and
a hinge component connected to the connecting column and the connecting portion, the connecting column and the hinge component being at least partially accommodated inside the accommodating chamber, the supporting frame being pivotally folded or unfolded relative to the case component by the hinge component, the hinge component being detachably connected to one of the connecting column and the connecting portion and integrally connected to another one of the connecting column and the connecting portion, or the hinge component being detachably connected to both of the connecting column and the connecting portion.

6. The electronic apparatus of claim 5, wherein the body portion further comprises a top wall, a left wall and a right wall, the top wall and the bottom wall are opposite to each other and extend along a width direction of the case device, the left wall and the right wall are opposite to each other and connected to the top wall and the bottom wall, the left wall and the right wall extend along a length direction of the case device, the connecting portion protrudes from the bottom wall of the body portion along the length direction of the case device, and the connecting column and the hinge component are at least partially accommodated inside the accommodating chamber along the width direction of the case device.

7. The electronic apparatus of claim 5, wherein the supporting frame comprises a left frame body, a right frame body and a connecting frame body, the left frame body and the right frame body are respectively adjacent to a left wall and a right wall of the body portion, the connecting frame body is connected to the left frame body and the right frame body, the connecting column is connected to the left frame body or the right frame body, the left frame body and the right frame body respectively overlap the left wall and the right wall of the body portion when the supporting frame is pivotally folded relative to the case component.

8. The electronic apparatus of claim 5, wherein the supporting frame is formed in U shape, L shape or J shape.
